(19) United States
(12) Patent Application Publication
(10) Pub. No.: US 2025/0025947 A1
(43) Pub. Date: Jan. 23, 2025

(54) METHOD FOR CUTTING STEEL SHEETS

(71) Applicant: EDGE – The Precision Blanks Company GmbH, Neustadt (DE)

(72) Inventors: Max BRANDT, Neustadt (DE); André BRANDT, Neustadt (DE)

(21) Appl. No.: 18/251,841

(22) PCT Filed: Nov. 5, 2020
(86) PCT No.: PCT/EP2020/081201

§ 371 Date: Nov. 27, 2023

(51) Int. Cl. B23C 3/13

(52) U.S. Cl. CPC B23C 3/13

(57) ABSTRACT

The present invention relates to a system and a method for cutting steel sheets by means of a milling cutter. For this purpose, a milling station is provided which comprises a liquid-cooled milling head, a milling table equipped to accommodate the steel sheet by means of a vacuum suction device for immobilizing the steel sheet to be machined, and an extraction device for extracting milling chips.

### FIELD OF THE INVENTION

The present invention relates to a method for cutting steel sheets by means of a milling cutter, and to an associated system.

### TECHNICAL BACKGROUND

In the prior art, the cutting of steel sheets, for example to produce blanks for car body molded parts, is usually carried out either by punching or laser welding. The starting material is typically a large steel sheet from which the desired shape is cut out and then processed to produce, for example, three-dimensional molded parts such as those used in car body construction. However, punching or laser welding of steel sheets has a number of disadvantages. Punching often results in edge cracks on the cutting edges. It is also known that such punching processes have an unfavorable effect on the metal structure at the separating edge. Similar problems arise during laser welding or laser cutting of sheet metal, as undesirable material changes can also occur at the edges due to the thermal impact.

EP 2 886 231 A1 of the same applicant describes a method of manufacturing a car body molded part in which a blank is cut out of a fine sheet section of light metal by means of a milling cutter. The basic idea of this earlier application is to provide machining for cutting out the blank. Light metal is particularly easy to machine, so that this method, which is known in the art, can be used to cost-effectively produce car body molded parts, or the blanks thereof, with high accuracy and high surface quality. Due to the good workability of light metal, the method known in the art allows the use of light machines of known design, with which high cutting speeds, and thus an economical production, are possible.

It is also known from the same publication that the machine table of the milling station can be equipped with a vacuum suction device for immobilizing the light metal sheet to be machined.

Although the method known in the art achieves excellent results in the processing of light metal sheets, the processing of steel sheets with the method known in the art is not easily, or economically, possible while maintaining good quality. In contrast to light metals, such as aluminum alloys in particular, steel is considerably more difficult to machine, so that the techniques known in the art cannot achieve sufficiently high cutting speeds to allow steel sheets to be cut economically.

It is therefore the object of the present invention to provide a method or a system for cutting steel sheets, with which steel sheets can be cut in an economical manner and in high quality. The resulting blanks can be used in particular for the production of car body molded parts, but any other applications of the molded parts are also conceivable.

These objects, as well as other objects which are still to be mentioned when reading the following description or which can be recognized by the person skilled in the art, are at least partially solved by a method for cutting steel sheets according to claim 1, as well as a system for cutting steel sheets according to claim 14.

### DETAILED DESCRIPTION OF THE INVENTION

According to the present invention, a method for cutting steel sheets by means of a milling cutter is provided. For this purpose, a milling station is provided which comprises a liquid-cooled milling head, a milling table equipped to accommodate the steel sheet, preferably by means of a vacuum suction device for immobilizing the steel sheet to be machined. In this respect, the liquid cooling of the milling head has at least two functions. On the one hand, it serves to cool the milling head, but on the other hand, it also removes the milling chips. Indeed, the present inventors have found that, for an economical machining of steel sheets, the effective and most complete possible removal of the milling chips during the milling or cutting process is very important. Setting a suitably high volume flow or pressure of the cooling liquid thus not only improves the cutting performance, but also simultaneously removes the milling chips from the machining area. The optional vacuum suction device of the milling table allows a quick and safe immobilization of the workpiece to be machined, as well as a quick change thereof. This vacuum clamping technology is thus not only a cost-effective and advantageous means of clamping or immobilizing with regard to workpiece change, but it also prevents damage to the surface of the workpiece that can result from the otherwise usual mechanical clamping.

Furthermore, according to the invention, the milling station is provided with an extraction device for extracting milling chips. The extraction device, in cooperation with the coolant, ensures that the chips are transported away as soon as they occur, allowing a fast and high quality milling performance even on steel sheets.

Furthermore, the milling station includes at least one groove in the milling table for partially accommodating the milling head during milling. In this regard, this groove corresponds to the cut contour of the sheet metal piece to be cut. Thus, when milling or cutting the steel sheet, the milling head or tool extends completely through the thickness of the steel sheet and at least partially into this groove (these grooves) in the milling table. The groove is helpful for successful removal of the milling chips just cut.

According to the invention, a provided steel sheet is immobilized on the milling table. This preferably takes places with the corresponding vacuum suction device of the milling table. After being immobilized on the milling table, the steel sheet is then cut with the milling head. High-speed cutting is advantageously used here.

In an advantageous further development, the milling head is internally cooled. The coolant is therefore not directed to the milling head from the outside, but passes through the milling head and exits preferably at its front end. Since the milling head is at least partially guided in the groove of the milling table, the coolant escaping from the end face of the milling head in the narrow groove channel ensures that the resulting milling chips are quickly and almost completely flushed away, to be then extracted by the extraction device.

Preferably, the milling head is provided with a circular internal channel coaxial with the axis of rotation. Coolant can be supplied through the internal channel to cool the milling head, but also to flush away the milling chips and lubricate the cutting surfaces. The internal channel preferably has an internal diameter d of 0.5 to 3 mm, even more preferably 0.6 to 2.5 mm, and most preferably 0.7 to 2 mm.

Preferably, the circular internal channel has a diameter d and the volume flow K of cooling liquid is adjusted as a function of the diameter d according to the following formula:

$$K \geq {( d / 2 )}^{2} * 3 ml / min ,$$

where d is the diameter in mm and only the magnitude of d is used in the formula without specifying mm. This formula allows for a particularly favorable ratio of volume flow to diameter of the channel, or advantageous flow velocity of the cooling liquid as it exits the milling head. In the formula, the diameter of the circular internal channel must be entered in millimeters, but the millimeter dimension is omitted. Thus, according to the above formula, an internal diameter of 1 mm results in a volume flow of 0.75 ml/min. A diameter of 1.8 mm results in a volume flow of 2.43 ml/min and a diameter of, for example, 1.3 mm results in a volume flow of 1.268 ml/min. These volume flows are minimum values or minimum limits for a given diameter. Accordingly, larger volume flows can also be selected, but preferably not smaller ones.

In another preferred embodiment, the volume flow is optimized for minimum quantity lubrication or cooling. This makes it possible to perform cutting processes very economically. The upper limit is thus:

$$K \leq {( d / 2 )}^{2} * 40 ml / min ,$$

$$and even more preferably :$$

$$K \leq {( d / 2 )}^{2} * 25 ml / min ,$$

where d is the diameter in mm and only the magnitude of d is used in the formula without specifying mm. With a diameter of 1 mm, for example, the upper limit for the volume flow is 10 ml/min, or even more preferably 6.25 ml/min. In general, it is preferable to select a volume flow that lies between the minimum and upper limits defined in this way.

In a preferred embodiment, the front end and/or further free surfaces of the milling head are optionally provided with at least one radially outwardly extending open flow channel for cooling liquid, which is arranged such that cooling liquid flows radially outwardly at the front end and/or over further free surfaces of the milling head. Such a flow channel guides the cooling liquid emerging from the internal channel at least partially radially outward from the center of the milling cutter. As the milling cutter rotates at high speed around its axis of rotation, a rotating flow of cooling liquid is thus generated, which diverts milling chips very well.

Preferably, the feed rate of the milling head when cutting the steel sheet is at least 8000 mm/min, more preferably at least 12,000 mm/min, even more preferably at least 20,000 mm/min, and most preferably at least 25,000 mm/min. These feed rates allow very economical production or cutting of steel sheets, which is made possible by the method according to the invention.

In a further preferred embodiment, the feed rate v of the milling head when cutting the steel sheet is set as a function of the thickness b of the sheet metal to be cut according to the following formula:

$$v \geq ( 1 / b ) * 15. mm / min ,$$

where b is the thickness in mm and only the magnitude of b is used in the formula without specifying mm. For example, if the thickness of the sheet metal is 0.5 mm, only the value 0.5 is used in b and the millimeter dimension is not used. For a sheet thickness of 0.5 mm, for example, this leads to a feed rate v of at least 30,000 mm/min. A sheet thickness of 0.8 mm, for example, leads to a feed rate v of at least 18,750 mm/min. These values can be used to determine optimum cutting speeds for various sheet thicknesses, at least as an approximate value.

In the preferred embodiment, the rotational speed of the milling head when cutting the steel sheet is at least 8000 revolutions/min, more preferably at least 12,000 revolutions/min, even more preferably at least 20,000 revolutions/min, and most preferably at least 25,000 revolutions/min. These values are advantageous for achieving fast and high-quality cutting performance with the method according to the invention.

The method according to the invention can preferably be used to machine steel sheets with a thickness of 0.4 to 5 mm, more preferably 0.5 to 4 mm and most preferably 0.5 to 2 mm. Such steel sheets have a wide range of applications and are particularly preferred for use as car body molded parts. With the method according to the invention, such thicknesses in particular can be cut quickly in high quality.

In a preferred embodiment, regardless of the shape and size of the cooling channel and the milling head, the cooling liquid is provided in an amount of at least 1 ml/min, more preferably at least 2 ml/min, even more preferably at least 2.5 ml/min, and most preferably at least 3 ml/min. It is particularly preferred that no more than 500 ml/min be dispensed, more preferably no more than 400 ml/min, and most preferably no more than 300 ml/min. Such cooling quantities ensure sufficient cooling of the milling head and also serve to ensure complete removal of the milling chips, which is advantageous. The pressure of the coolant is thus sufficient to loosen the milling chips immediately after their production and to flush them free so that they can be easily picked up by the extraction device. This is particularly advantageous if the milling head is cooled internally, i.e., if the coolant is guided through the interior of the milling head and exits, for example, at the free end of the milling head. The quantities of cooling liquid that 30 exit at the milling head, together with the groove in which the milling head runs, ensure that almost all chips produced are flushed out immediately and almost completely, so that they cannot negatively affect the cutting performance of the milling head.

Preferably, the milling station comprises air nozzles arranged in a ring-shaped manner around the milling head, through which an air flow is emitted in the direction of the steel sheet to be machined. Even more preferably, the air flow is in this process adjusted in a way that it guides the chips towards the milling head when cutting the steel sheet. In a manner of speaking, the air nozzles create an “air curtain” which is directed downwards from the milling head towards the sheet metal and preferably completely surrounds the milling head in ring-shaped manner. The flow velocity essentially corresponds to the axis of rotation of the milling head, with the air flow preferably being directed slightly inwards, i.e. towards the milling head, so that milling chips can be prevented from leaving the immediate working area of the milling head in an uncontrolled manner. Instead, the freshly cut chips remain in the proximity of the extraction device so that they can be extracted quickly and efficiently.

According to a preferred embodiment, the cutting edge(s) of the milling head is/are arranged helically. The helix angle is preferably 14 to 16°, more preferably 12 to 14°, even more preferably 10 to 12°, and most preferably 8 to 10°. The milling head can thus be equipped with a single cutting edge that winds around the head in a helix-like manner. Preferably, however, the milling head has several cutters/cutting edges. These angles have proven to be particularly advantageous in cutting thin steel sheets and allow high cutting performance at good quality.

The following invention also relates to a system for cutting steel sheets by means of a milling cutter, said system comprising a milling station. The milling station comprises a liquid-cooled milling head, a milling table equipped to accommodate a steel sheet, preferably by means of a vacuum suction device for immobilizing the steel sheet to be machined, an extraction device for extracting milling chips, and at least one groove in the milling table for partially accommodating the milling head during milling, with said groove corresponding to the cut contour. The milling station is further configured to cut the steel sheet clamped in the vacuum suction device at a feed rate of the milling head of at least 8000 mm/min. The advantages of such a milling station or milling system correspond to those described above in connection with the method according to the invention.

The system according to the invention is preferably configured to cut steel sheets with a thickness from 0.4 to 5 mm, more preferably 0.5 to 4 mm, and most preferably 0.5 to 3 mm. Again, the advantages are the same as those described above in connection with the method.

In a preferred embodiment, the extraction device is arranged in a ring-shaped manner around the milling head and has a plurality of extraction openings arranged radially around the milling head. The cutting edge(s) of the milling head are preferably arranged in a helical shape with a helix angle (also called angle of twist) of 8 to 16°, preferably 9 to 15°, more preferably 10 to 12°, and most preferably 10°.

The disclosure set out above in connection with the method, i.e., for example, figures, facts, mode of operation, advantages, connections, etc., also applies analogously to the system.

### DESCRIPTION OF PREFERRED EMBODIMENTS

Below, the present invention will be explained in more detail with reference to the enclosed figures. The figures show the following:

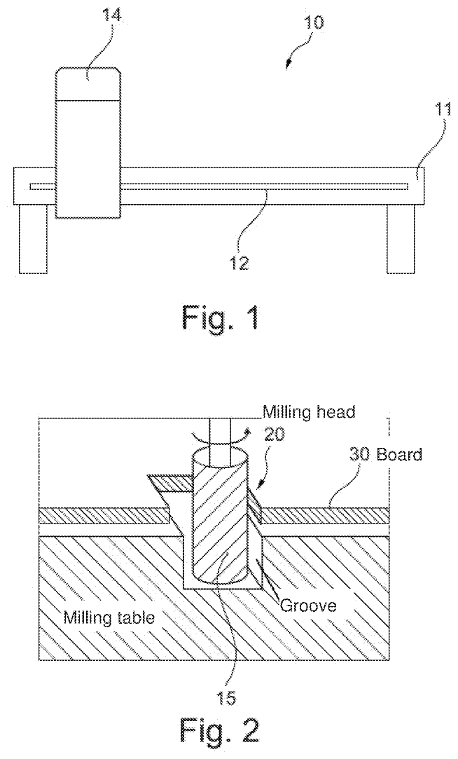

FIG. 1 an example of a portal milling machine for carrying out the method according to the invention;

FIG. 2 schematically a milling head according to the invention cutting a steel sheet;

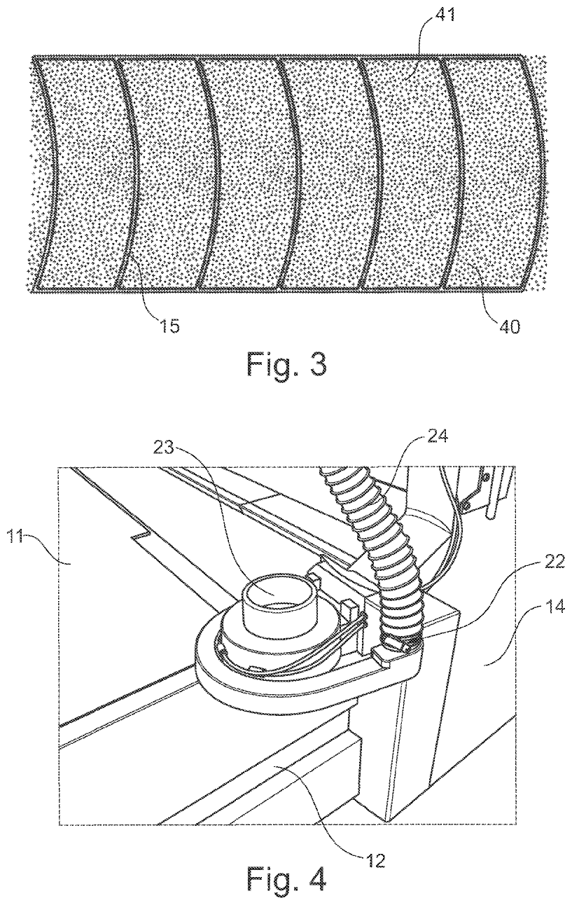

FIG. 3 an adapter plate for the milling table.

FIG. 4 schematically an extraction device for extracting milling chips;

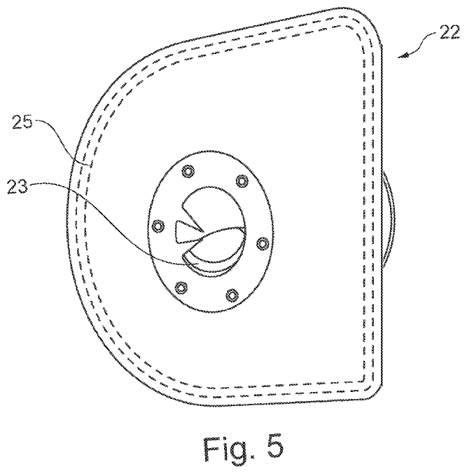

FIG. 5 the bottom side of the extraction device shown in FIG. 4,

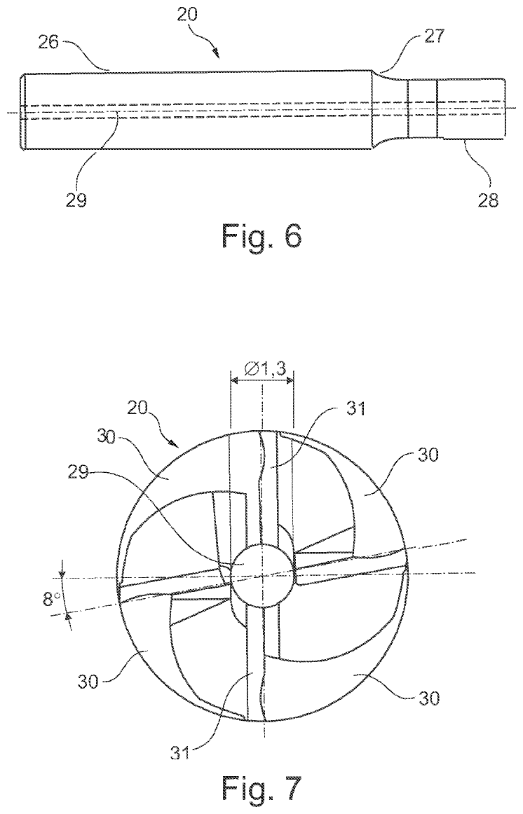

FIG. 6 a longitudinal view of a milling head;

FIG. 7 a top view of the end face of the milling head of FIG. 6 in enlarged view; and

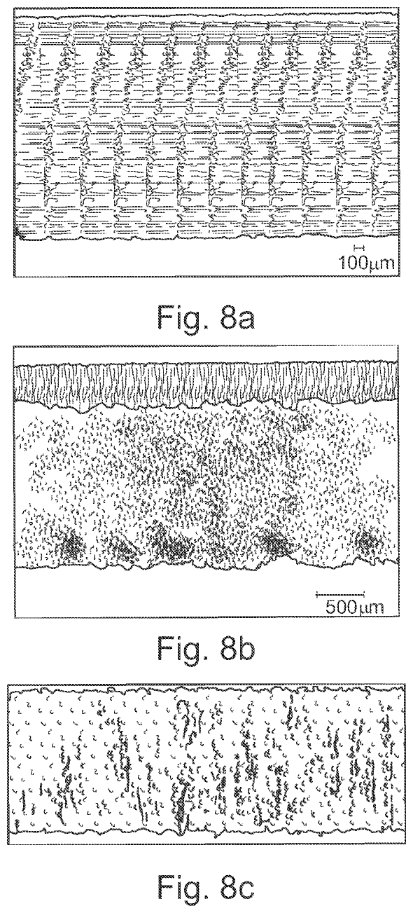

FIGS. 8a to 8c comparative microscope images of cut edges.

FIG. 1 shows a schematic side view of a milling station 10. The station comprises a milling table 11 and a portal milling cutter 14, which can be moved along the milling table 11 by means of rails 12. The portal milling cutter 14 preferably carries a liquid-cooled milling head as well as an extraction device for extracting milling chips. The milling head is movably arranged on the portal milling cutter 14 in a common manner so that the milling head itself can be moved freely over the milling table 11.

FIG. 2 shows the cutting of a steel sheet 50 by means of a milling head 20 in a schematic view. The front end of the milling head 20 is partially guided in a groove 15, which defines the cut contour for the starting sheet 50. The groove itself is slightly wider than the diameter of the milling head and several millimeters deep. It is particularly advantageous if the milling head 20 is cooled internally by means of a cooling liquid which emerges at its front end. The cooling liquid emerging under pressure removes the milling chips from the immediate cutting area quickly and reliably so that they can be removed by the extraction device.

FIG. 3 schematically shows an exemplary adapter plate 40 for the milling table 11. The adapter plate 40 shown in FIG. 3 can be inserted into the actual milling table 11 and forms the workpiece support surface for the steel sheet. As already described in EP 2 886 231 of the same applicant mentioned at the beginning, the milling machine 10 has a number of extraction openings for this purpose, which are connected within the milling table 11 and are connected to a vacuum source in the form of a vacuum pump. The adapter plate 40 itself may, for example, be made of an aluminum plate that is a few millimeters thick and is provided with a large number of holes 41 to allow the steel plate to be suctioned. For example, there are several thousand vacuum holes 41 per square meter of the adapter plate 40. The adapter plate 40 shown schematically in FIG. 3, for example, has dimensions of 1500×2200×4 mm and has 4650 holes distributed as homogeneously as possible over the surface.

The grooves 15, which ultimately define the cut contour of the sheet metal pieces to be cut out, can also be seen in the adapter plate 40. With the adapter plate shown, for example, six pieces can be cut out of a clamped steel sheet. The vacuum holes 41 permit secure immobilizing of the sheet to be machined.

FIG. 4 shows an extraction device 22 which has a continuous cylindrical recess 23 for accommodating or passing through the milling head 20. The extraction device 22 is movably held on the portal milling cutter 14 and can be moved (together with the milling head) transversely across the milling table, i.e. to the top left in the perspective shown in FIG. 4. At the same time, the portal milling cutter 14 is configured to move longitudinally along the milling table 11 by means of the rails 12, so that the extraction device 22 can be moved freely over the surface of the milling table 11 or an adapter plate 40 arranged therein. Chips are extracted via an opening provided on an inner wall of the recess 23. The extraction device 22 is connected to a vacuum device (not shown) via an extraction hose 24.

FIG. 5 shows the bottom side of the extraction device 22 of FIG. 4. The cylindrical recess 23 through which the milling head (not shown here) is passed can be seen. The extraction device 22 additionally has air nozzles 25 that are arranged in a ring-shaped manner around the milling head. The air nozzles generate an air flow which is directed in the direction of the workpiece to be worked and forms an “air curtain” around the milling head. This can effectively prevent milling chips from moving out of the immediate machining area and ending up, for example, on the surface of the sheet metal, where they can cause surface damage. Essentially, the chips thus remain within the ring-shaped arrangement of the air nozzles 25. It is advantageous for the air nozzles 25 to be configured in such a way that the air flow generated by them is directed inwards and guides the chips in the direction of the cylindrical recess 23, and thus in the direction of the extraction device.

FIG. 6 shows a milling head 20 according to the invention in a schematic lateral view. The milling head 20 has a shank 26 and a cutting area 28. The transition 27 between the shank and the cutting area is rounded and has a radius R. The radius R is advantageously not constant, but has an exponential course. This non-constant radius enables a transition between the shank area and the cutting area that is particularly mechanically stable. The milling head 20 can, for example, have a total length of 30-60 mm and a diameter of 1-10 mm. The cutting area is 0.5-10 mm long. The milling head is equipped with a circular internal channel 29 which extends over the entire axial length of the milling head. This internal channel 29 serves to pass cooling liquid through. The cooling liquid advantageously emerges under high pressure at the end face and/or other free surfaces of the milling head, and ensures cooling of the milling head and effective removal of the chips.

FIG. 7 shows a schematic top view of the front end of the milling head 20. Four cutters 30 and the opening of the internal channel 29 can be seen. The front end of the milling head has two open flow channels 31 which extend radially outward from the opening of the internal channel 29. These open flow channels 31 discharge cooling liquid radially outward and ensure particularly effective removal of the milling chips.

FIGS. 8a, 8b and 8c show microscopic images of cut edges. FIG. 8a shows the cut edge of a steel sheet which was cut using the method according to the invention. The cut is uniform over the entire thickness of the sheet. FIG. 8b shows the cut edge of a steel sheet which was processed using a conventional punching method. A clear material deformation can be seen in the upper area, which was caused by the impact of the punching tool. FIG. 8c shows the cut edge of a steel sheet which was processed using a conventional laser method. In the upper area, there is clear material damage caused by the heat input of the laser beam. Such cut edges in FIGS. 8b and 8c must be extensively reworked mechanically to produce a surface that is as smooth as possible. In contrast, the cut edge in FIG. 8a, which was created according to the invention, is considerably more uniform and exhibits significantly less material deformation, so that post-processing of the cutting edge is not necessary.

1. A method for cutting steel sheets by means of a milling cutter, comprising:
a) providing a milling station, said milling station comprising:
a liquid-cooled milling head,
a milling table equipped to accommodate the steel sheet preferably by means of a vacuum suction device for immobilizing the steel sheet to be machined,
an extraction device for extracting milling chips, and
at least one groove in the milling table for partially accommodating the milling head during milling, with said groove corresponding to the cut contour;
b) providing a steel sheet;
c) immobilizing the steel sheet on the milling table;
d) after steps a) through c): cutting the steel sheet by means of the milling head, particularly by means of high-speed cutting.

2. A method for cutting steel sheets by means of a milling cutter according to claim 1, wherein the milling head is internally cooled.

3. A method for cutting steel sheets by means of a milling cutter according to claim 2, wherein the milling head is provided with a circular internal channel coaxial with the axis of rotation, having an internal diameter d of 0.5 to 3 mm.

4. A method for cutting steel sheets by means of a milling cutter according to claim 3, wherein the circular internal channel has a diameter d and the volume flow K of cooling liquid is adjusted as a function of the diameter d according to the following formula:
$$K \geq {( d / 2 )}^{2} * 3 ml / min ,$$
where d is the diameter in mm and only the magnitude of d is used in the formula without specifying mm.

5. A method for cutting steel sheets by means of a milling cutter according to claim 3, wherein the circular internal channel has a diameter d and the upper limit for the volume flow K of cooling liquid is adjusted as a function of the diameter d according to the following formula:
$$K \leq {( d / 2 )}^{2} * 40 ml / min ,$$
where d is the diameter in mm and only the magnitude of d is used in the formula without specifying mm.

6. A method for cutting steel sheets by means of a milling cutter according to claim 1, wherein the front end of the milling head is provided with at least one radially outwardly extending open flow channel for cooling liquid, which is arranged such that cooling liquid flows radially outwardly at the front end of the milling head.

7. A method for cutting steel sheets by means of a milling cutter according to claim 1, wherein the feed rate v of the milling head when cutting the steel sheet is at least 8000 mm/min.

8. A method for cutting steel sheets by means of a milling cutter according to claim 1, wherein the feed rate v of the milling head when cutting the steel sheet is set as a function of the thickness b of the sheet metal to be cut according to the following formula:
$$v \geq ( 1 / b ) * 15. mm / min ,$$
where b is the thickness in mm and only the magnitude of b is used in the formula without specifying mm.

9. A method for cutting steel sheets by means of a milling cutter according to claim 1, wherein the rotational speed of the milling head when cutting the steel sheet is at least 8000 rpm.

10. A method for cutting steel sheets by means of a milling cutter according to claim 1, wherein the provided steel sheet has a thickness of 0.4 to 5 mm.

11. A method for cutting steel sheets by means of a milling cutter according to claim 1, wherein the milling station comprises air nozzles arranged in a ring-shaped manner around the milling head, through which an air flow is emitted in the direction of the steel sheet to be machined.

12. A method for cutting steel sheets by means of a milling cutter according to claim 1, wherein the air flow is adjusted in a way that it guides the chips towards the milling head when cutting the steel sheet.

13. A method for cutting steel sheets by means of a milling cutter according to claim 1, wherein the cutting edge(s) of the milling head is/are arranged in a helical shape with a helix angle of 14 to 16°.

14. A system for cutting steel sheets by means of a milling cutter, comprising:
a milling station, said milling station comprising:
a liquid-cooled milling head,
a milling table equipped to accommodate a steel sheet preferably by means of a vacuum suction device for immobilizing the steel sheet to be machined,
an extraction device for extracting milling chips, and
at least one groove in the milling table for partially accommodating the milling head during milling, with said groove corresponding to the cut contour;
wherein the milling station is configured to cut the steel sheet at a feed rate of the milling head of at least 8000 mm/min.

15. A system for cutting steel sheets by means of a milling cutter according to claim 14, wherein the milling head is internally cooled.

16. A system for cutting steel sheets by means of a milling cutter according to claim 15, wherein the milling head is provided with a circular internal channel coaxial with the axis of rotation, having an internal diameter of 0.5 to 3 mm.

17. A system for cutting steel sheets by means of a milling cutter according to claim 16, wherein the circular internal channel has a diameter d and the volume flow K of cooling liquid is adjusted as a function of the diameter d according to the following formula:
$$K \geq {( d / 2 )}^{2} * 3 ml / min ,$$
where d is the diameter in mm and only the magnitude of d is used in the formula without specifying mm.

18. A system for cutting steel sheets by means of a milling cutter according to claim 16, wherein the circular internal channel has a diameter d and the upper limit for the volume flow K of cooling liquid is adjusted as a function of the diameter d according to the following formula:
$$K \leq {( d / 2 )}^{2} * 40 ml / min ,$$
where d is the diameter in mm and only the magnitude of d is used in the formula without specifying mm.

19. A system for cutting steel sheets by means of a milling cutter according to claim 14, wherein the front end of the milling head is provided with at least one radially outwardly extending open flow channel for cooling liquid, which is arranged such that cooling liquid flows radially outwardly at the front end of the milling head.

20. A system for cutting steel sheets by means of a milling cutter according to claim 14, wherein the system is configured to cut steel sheets having a thickness of 0.4 to 5 mm.

21. A system for cutting steel sheets by means of a milling cutter according to claim 14, wherein the milling station comprises air nozzles arranged in a ring-shaped manner around the milling head, through which an air flow is emitted in the direction of the steel sheet to be machined.

22. A system for cutting steel sheets by means of a milling cutter according to claim 14, wherein the air nozzles are arranged such that the outgoing air flow guides the chips towards the milling head when cutting the steel sheet.

23. A system for cutting steel sheets by means of a milling cutter according to claim 14, wherein the cutting edge(s) of the milling head is/are arranged in a helical shape with a helix angle of 14 to 16°.
